(19) United States
(12) Patent Application Publication
(10) Pub. No.: US 2013/0104681 A1
(43) Pub. Date: May 2, 2013

(54) GEARBOX IN A TURBINE ENGINE

(71) Applicant: Jean-Pierre Elie Galivel, Savigny Le Temple (FR)

(72) Inventor: Jean-Pierre Elie Galivel, Savigny Le Temple (FR)

(73) Assignee: SNECMA, Paris (FR)

(21) Appl. No.: 13/699,949

(22) PCT Filed: May 17, 2011
(86) PCT No.: PCT/FR2011/051107

§ 371 Date: Jan. 14, 2013

(30) Foreign Application Priority Data
May 25, 2010 (FR) 1054038

(51) Int. Cl. F16H 1/04

(52) U.S. Cl. CPC F16H 1/04
USPC 74/412 R

(57) ABSTRACT

A gearbox in a turbine engine for imparting rotary drive to at least one piece of rotary equipment, the gearbox including a transmission shaft guided in rotation in bearings and carrying a toothed wheel meshing with at least one rotary drive gearwheel. One of the bearings is a rolling bearing mounted inside the toothed wheel in a radial plane containing the toothed wheel and the drive gearwheel, and another of the bearings is a smooth bearing for taking up forces tending to tilt the transmission shaft.

The present invention relates to a gearbox for imparting rotary drive to equipment in a turbine engine.

In a turbine engine, various pieces of equipment, such as in particular pumps for producing hydraulic energy, feeding fuel, or providing lubrication, and electricity generators for producing electrical power, etc., are driven in rotation by a gearbox connected to a shaft of the turbine engine.

Each piece of equipment has a rotary shaft coupled in rotation with a transmission shaft of the gearbox. Each transmission shaft carries on its outside a toothed wheel meshing with a drive gearwheel that is coupled by a gear train to a compressor shaft of the turbine engine.

The transmission shaft is guided in rotation at its ends in two rolling bearings having outer rings that are stationary, since they are fastened to walls of the gearbox.

In order to reduce the cost of gearboxes, recourse is made to standardized bearings. As a result, the bearings used are often overdimensioned relative to the required use. The use of bearings specially adapted to the intended uses would make it possible to reduce the weight of the gearbox, but only very little, since that would have little or no impact on the dimensioning of the gearbox, of the various fastener elements, lubrication means, etc.

The walls of the gearbox also have projections for mounting the rolling bearings. These portions of the gearbox are also reinforced to enable them to transmit forces in operation, thereby increasing the weight of the gearbox. Furthermore, each bearing requires its own lubrication circuit, thereby further complicating the design of the gearbox.

A particular object of the present invention is to provide a solution to those problems of the prior art that is simple, effective, and inexpensive.

To this end, the invention provides a gearbox in a turbine engine for imparting rotary drive to at least one piece of rotary equipment, such as for example an alternator or a pump, the gearbox having a transmission shaft guided in rotation in bearings and carrying a toothed wheel meshing with at least one rotary drive gearwheel, the gearbox being characterized in that one of the bearings is a rolling bearing mounted inside the toothed wheel in a radial plane containing the toothed wheel and the drive gearwheel, and in that the other bearing is a smooth bearing for taking up forces tending to tilt the transmission shaft.

According to the invention, the transmission shaft is guided by only one rolling bearing, the other bearing being a smooth bearing having no rolling elements. Arranging the rolling bearing in the radial plane that contains the toothed wheel and the drive gearwheel makes it possible to take up all of the radial load due to the meshing between the toothed wheel and the drive gearwheel.

The smooth bearing does not take up radial forces but serves only to take up forces tending to tilt the transmission shaft. It is therefore possible for its dimensions to be greatly reduced, thereby making it possible to envisage optimizing the weight of the gearbox.

Replacing a rolling bearing with a smooth bearing serves to reduce the number of high-cost parts in the gearbox. Furthermore, insofar as the smooth bearing is lightly loaded, as it is in gearboxes of the invention, it does not require its own oil feed and is found to be more reliable than a rolling bearing, the smooth bearing can be lubricated by the surrounding mist of oil.

According to another characteristic of the invention, the two bearings are mounted at respective ends of the transmission shaft.

Advantageously, the axial movement of the shaft in the gearbox of the invention is limited by two axial abutments, one of which is formed by an annular rim at the rear end of the outer ring of the rolling bearing and the other of which is formed by a front annular rim of the transmission shaft co-operating with the rear end of a stationary ring of the smooth bearing.

These two abutments serve to limit axial movement of the transmission shaft due to the rolling bearing sliding on its raceway and thus serve to guarantee good radial alignment for the bearing and the toothed wheel.

According to yet another characteristic of the invention, the toothed wheel is connected to the transmission shaft by a frustoconical wall.

Advantageously, the smooth bearing comprises a ring mounted in a bore in a wall of the gearbox.

According to another characteristic of the invention, the end of the transmission shaft that is guided in rotation in the smooth bearing forms a hub having a fluted inside surface for receiving a fluted end of a rotary shaft of the rotary equipment.

The smooth bearing may be made of bronze or of composite material.

According to yet another characteristic of the invention, the rolling bearing comprises an inner ring mounted on a cylindrical bearing surface of the transmission shaft and an outer ring carried by a cylindrical endpiece secured to a wall of the gearbox.

The rolling bearing may be a bearing of the roller type or of the ball type. A roller bearing presents the advantage over a ball bearing of providing better take-up of the radial loads due to the meshing of the toothed wheel.

The invention also provides a turbine engine, such as a turboprop or a turbojet, and including a gearbox as described above.

The invention can be better understood and other details, advantages, and characteristics of the invention appear on reading the following description made by way of non-limiting example and with reference to the accompanying drawings, in which:

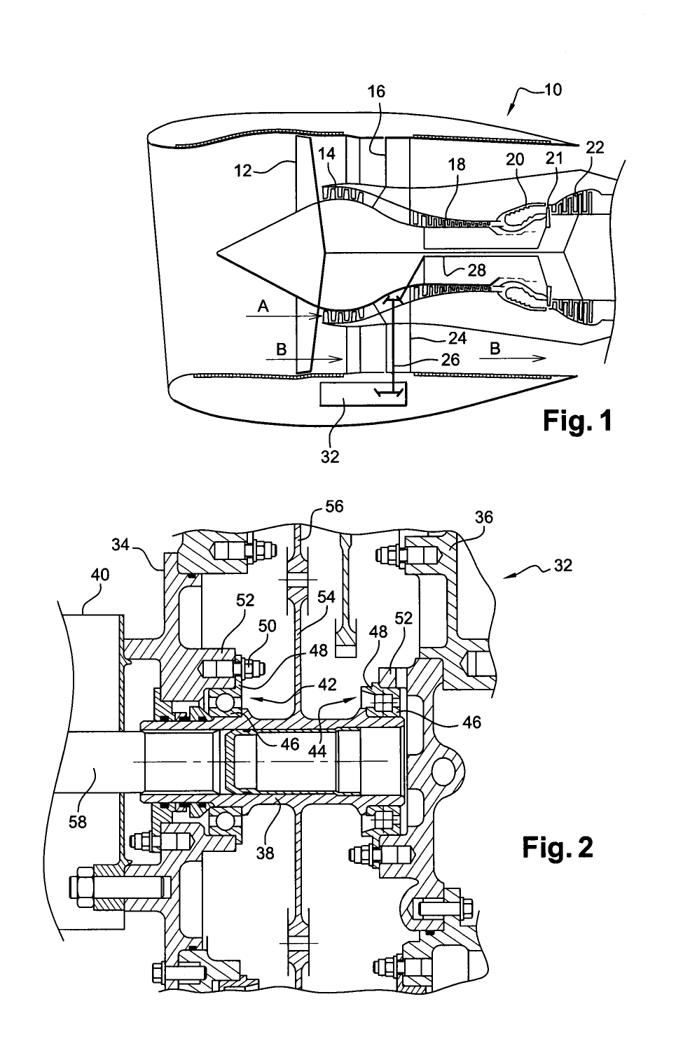

FIG. 1 is a diagrammatic axial section view of a turbine engine;

FIG. 2 is a diagrammatic axial section view of a portion of a gearbox of the prior art;

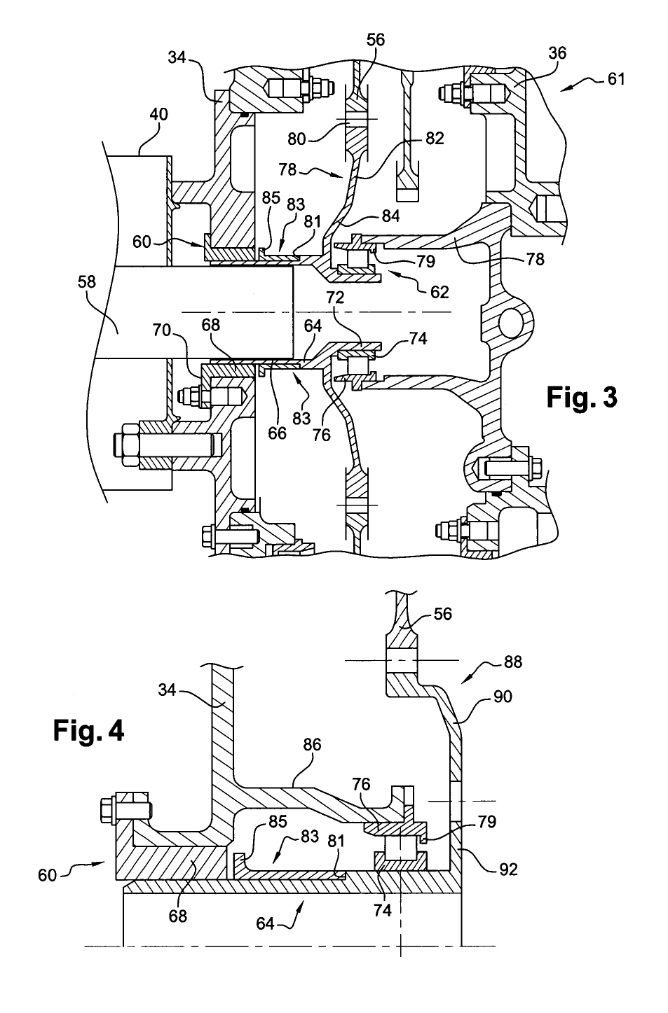

FIG. 3 is a diagrammatic axial section view of a portion of a gearbox of the invention; and

FIG. 4 is a diagrammatic axial section view of a variant embodiment of the gearbox of the invention.

Reference is made initially to FIG. 1, which shows a turbine engine 10 that comprises, from upstream to downstream: a fan 12; a low-pressure compressor 14; an intermediate casing 16; a high-pressure compressor 18; a combustion chamber 20; a high-pressure turbine 21; and a low-pressure turbine 22. Air entering into the turbine engine splits both into a primary air stream (arrow A) that flows through the low and high-pressure compressors 14 and 18 towards the combustion chamber 20, and then through the high and low-pressure turbines 21 and 22, and also into a secondary (bypass) air stream (arrows B) that flows around the compressor 14, 18, the combustion chamber 20, and the turbine 21, 22.

The intermediate casing 16 has structural arms 24 extending radially outwards. One of the arms 24 of the intermediate casing 16 contains a radial shaft 26 having its inner end connected via a pair of bevel gears to the drive shaft 28 of the high-pressure compressor 18. The radially outer end of the radial shaft 26 is connected via another pair of bevel gears to the inlet of a gearbox 32 that has gearwheels driving various pieces of equipment, such as, for example: an oil pump, a hydraulic pump, a fuel pump, a starter, and an electricity generator.

FIG. 2 shows a portion of a gearbox 32 of the prior art. Such a gearbox 32 has a front side wall 34 and a rear side wall 36 between which there extend a plurality of transmission shafts 38, each coupled to a respective piece of rotary equipment 40.

The transmission shaft 38 is guided in rotation at its ends in two rolling bearings, one of which 42 is a ball bearing and the other of which 44 is a roller bearing. Each bearing 42, 44 comprises an inner ring 46 carried by the transmission shaft 38 and an outer ring 48 fastened by means of screws 50 to projections 52 on the front or rear walls 34 or 36. Each bearing 42, 44 is fed with oil by a specific lubrication circuit.

The transmission shaft 38 carries a toothed wheel 54 arranged between the two rolling bearings 42 and 44 and meshing with a drive gearwheel 56.

The housing 40 of a piece of equipment is fastened by means of screws or a fastening collar to the front side wall 34. This piece of equipment has a drive shaft 58 with an outside surface including axial fluting engaged in complementary axial fluting inside the transmission shaft 38.

In operation, radial loads due to meshing between the toothed wheel 54 and the drive gearwheel 56 are taken up by both of the bearings 42 and 44.

That type of configuration is nevertheless not satisfactory since it requires two standardized rolling bearings 42 and 44 to be used, which bearings are often overdimensioned.

The invention provides a solution to that drawback and also to those mentioned above by replacing the ball bearing with a smooth bearing 60 and by offsetting the roller bearing 62 into the radial plane occupied by the drive gearwheel 56.

As shown in FIG. 3, the transmission shaft 64 has a substantially conical front portion 66 with its end engaged in and guided in rotation by a ring 68 of a smooth bearing 60. This ring is mounted in a bore of the front wall 34 of the gearbox 61 and includes a rim 70 fastened by screws to the front wall 34.

The rear end of the transmission shaft 64 has a cylindrical bearing surface 72 carrying the inner ring 74 of the roller bearing 62. The outer ring 76 of this bearing is carried by the front end of a cylindrical endpiece 78 secured to the rear wall 36 of the gearbox 61.

The rear end of the outer ring 76 secured to the endpiece 78 includes an inwardly-directed radial annular rim 79. The shaft 64 includes a shoulder 81 against which the rear end of a ring 83 bears, the front end of the ring having a radial annular rim 85. The ring 83 is axially dimensioned in such a manner that the annular rim 85 is spaced apart from the rear end of the stationary ring 68 by clearance identical to the clearance between the roller bearing and the abutment 79. The two annular rims 79 and 85 form axial abutments limiting the movement of the rotor line as a result of the roller bearing sliding on its raceway. These abutments 79 and 85 thus enable the bearing 62 to be kept in alignment with the toothed wheel 56.

Incorporating an abutment 85 that limits the sliding of the shaft 64 towards the rear wall 36 is made necessary by the fact that a smooth bearing 60 is used instead of a rolling bearing that, in the prior art, incorporated a radial rim forming the second axial abutment.

The toothed wheel 78 carried by the shaft 64 meshes via its outer periphery with the drive gearwheel 56. The meshing teeth of the toothed wheel and of the gearwheel lie in a radial plane that passes through the roller bearing 62. The toothed wheel 78 is connected to the front end of the cylindrical bearing surface 72 via a circularly symmetrical wall having an outer first portion 82 that is substantially radial and an inner second portion 84 that is frustoconical and connected to the cylindrical bearing surface 72. This frustoconical wall portion 84 makes a space available along the shaft 64 that can be used for mounting the roller bearing 62 in register with the drive gearwheel 56.

In a variant embodiment of the invention shown in FIG. 4, the endpiece 86 carrying the outer ring 76 is secured to the front wall 34 of the gearbox. In this embodiment, the toothed wheel 88 connected to the rear end of the shaft 64 has a frustoconical outer first portion 90 carrying a set of teeth meshing with a set of teeth of the gearwheel 56, and a substantially radial inner second portion 92. In this configuration, the shaft 64 and the two bearings 60 and 62 are carried by the front wall 34 of the gearbox, thereby making it possible to perform assembly from in front in a manner that is simpler than for the above-described assembly. The shaft 64 is held axially in position in a manner identical to that described with reference to FIG. 3.

By means of the configuration of the invention, the radial load can be taken up in full by the roller bearing 62 and the smooth bearing 60 serves to prevent the transmission shaft 64 from tilting. The radial dimension of the smooth bearing 60 may be small in comparison with that of a ball bearing. Such a smooth bearing 60 is also more reliable than a ball bearing and does not necessarily require a specific lubrication circuit.

The invention is not limited to using a roller bearing as described with reference to FIGS. 3 and 4, and it is also possible to replace the roller bearing with a ball bearing.

Although only one piece of equipment 40 is visible in FIG. 3, it is clear that the invention is applicable to all of the transmission shafts of the gearbox.

1-11. (canceled)

12. A gearbox in a turbine engine for imparting rotary drive to at least one piece of rotary equipment, or an alternator or a pump, the gearbox comprising:
a transmission shaft guided in rotation in bearings and carrying a toothed wheel meshing with at least one rotary drive gearwheel,
wherein one of the bearings is a rolling bearing mounted inside the toothed wheel in a radial plane containing the toothed wheel and the drive gearwheel, and the other bearing is a smooth bearing for taking up forces tending to tilt the transmission shaft.

13. A gearbox according to claim 12, wherein the two bearings are mounted at respective ends of the transmission shaft.

14. A gearbox according to claim 12, wherein the smooth bearing comprises a ring mounted in a bore in a wall of the gearbox.

15. A gearbox according to claim 14, wherein one end of the transmission shaft is guided in rotation in the smooth bearing.

16. A gearbox according to claim 12, wherein the smooth bearing is made of bronze or of composite material.

17. A gearbox according to claim 12, wherein the rolling bearing comprises an inner ring mounted on the transmission shaft and an outer ring carried by a cylindrical endpiece secured to a wall of the gearbox.

18. A gearbox according to claim 17, wherein axial movement of the shaft is limited by two axial abutments, one of which is formed by an annular rim at a rear end of the outer ring and the other of which is formed by a front annular rim of the transmission shaft co-operating with a rear end of a stationary ring of the smooth bearing.

19. A gearbox according to claim 12, wherein the toothed wheel is connected to the transmission shaft by a frustoconical wall.

20. A gearbox according to claim 12, wherein the end of the transmission shaft that is guided by the smooth bearing forms a hub having a fluted inside surface for receiving a fluted end of a rotary shaft of the rotary equipment.

21. A gearbox according to claim 12, wherein the rolling bearing is a bearing of roller type or of ball type.

22. A turbine engine, a turboprop, or a turbojet, comprising a gearbox according to claim 12.
